(19) United States
(12) Patent Application Publication
(10) Pub. No.: US 2018/0063881 A1
(43) Pub. Date: Mar. 1, 2018

(54) EFFICIENT WAY OF REACQUIRING A CELL AND RESUMING A DATA CALL ON ONE SUBSCRIPTION AFTER TUNE AWAY FROM OTHER SUBSCRIPTION FOR A MULTI-SIM DEVICE

(71) Applicant: QUALCOMM Incorporated, San Diego, CA (US)

(72) Inventors: Sagar Bharatkumar SHAH, San Diego, CA (US); Yi SU, San Jose, CA (US); Gautham JAYARAM, San Diego, CA (US); Darshan Bharat ASHAR, San Diego, CA (US)

(21) Appl. No.: 15/254,861

(22) Filed: Sep. 1, 2016

(51) Int. Cl. H04W 76/02; H04B 17/318; H04L 5/00

(52) U.S. Cl. CPC H04W 76/028; H04W 88/06; H04L 5/0048; H04B 17/318

(57) ABSTRACT

A method for reacquiring a cell after tune-away for an MSMS mobile communication device includes: measuring pilot signal energy of a cell on which a data call was suspended on a first subscription before tune-away; determining whether the measured pilot signal energy is less than a high threshold RSSI value; determining whether a difference between a measured cell timing and a pre-tune-away cell timing is less than a first threshold timing value; determining whether a strongest pilot signal energy received on one of a plurality of rake fingers is greater than a low threshold RSSI value; decreasing the low threshold RSSI value for reacquiring the cell; and in response to determining that the measured RSSI for the strongest pilot signal energy received on one of the plurality of the receiver rake fingers is not less than the decreased minimum threshold RSSI value, reacquiring the cell and resuming the data call.

### BACKGROUND

A multi-subscriber identity module (SIM) multi-standby (MSMS) mobile communication device supports more than one subscription. Similarly, a dual-SIM dual-standby (DSDS) mobile communication device supports services for two subscriptions simultaneously (e.g., monitoring the paging channel for mobile terminated voice calls for both subscriptions simultaneously, supporting an active data call on one subscription while monitoring paging channel on the other subscription, etc.). Further, the mobile communication device may support different radio access technologies (RATs) for each subscription.

In some cases, a mobile communication device may support a data call on a first subscription while it tunes away the radio frequency (RF) chain to another frequency band to monitor the paging channel for a second subscription. For example, a first RAT may be wideband code division multiple access (WCDMA) for a first subscription where a data call is established and a second RAT may be code division multiple access (CDMA) for a second subscription where the second subscription is in an idle state and periodically monitoring the paging channel.

The process of RF tune-away involves pausing or suspending the on-going data call on the first subscription which necessitates tearing down data channels, stopping the transmission and reception of data packets, and tuning the RF chain to the band on which the second subscription is registered to monitor the paging channel for the second subscription. If no page is received for the second subscription, the mobile communication device will tune the RF chain back to the frequency band on which the first subscription was active.

After tuning the RF chain back, the mobile communication device performs measurements and attempts to reacquire the cell to resume the data call that was suspended on the first subscription. If changes in cell timing and associated measured signal energies before and after the tune-away are minimal, the mobile communication device may be able to reacquire the cell and resume the data call on the first subscription seamlessly. However, in many cases, after the mobile communication device tunes back to the frequency band on which the first subscription was active the measurement attempts fail to find signals with high enough energies for the same cell, for example, due to a deep fade in the signal. The failed measurement attempts may cause the mobile communication device to abort the acquisition process and thereby cause a radio link failure for the data call on the first subscription.

### SUMMARY

Apparatuses and methods for reacquiring a cell and resuming a data call after tune away for a multi-SIM mobile communication device are provided.

According to various aspects there is provided a method for reacquiring a cell after tune-away for a multi-subscriber identity module (SIM) multi-standby (MSMS) mobile communication device. In some aspects, the method may include: measuring pilot signal energy of a cell on which a data call was suspended on a first subscription before tune-away to a second subscription; determining whether the measured pilot signal energy is less than a high threshold received signal strength indicator (RSSI) value; in response to determining that the measured pilot signal energy is less than the high threshold RSSI value, determining whether a difference between a measured cell timing and a pre-tune-away cell timing is less than a first threshold timing value; in response to determining that the difference between the measured cell timing and the pre-tune-away cell timing is less than the first threshold timing value, determining whether a strongest pilot signal energy received on one of a plurality of receiver rake fingers is greater than a low threshold RSSI value; in response to determining that the strongest pilot signal energy received on one of the plurality of receiver rake fingers is greater than the low threshold RSSI value, decreasing the low threshold RSSI value for reacquiring the cell; determining, after a next tune-away, whether the strongest pilot signal energy received on one of the plurality of receiver rake fingers is less than the decreased low threshold RSSI value; and in response to determining that the measured RSSI for the strongest pilot signal energy received on one of the plurality of the receiver rake fingers is not less than the decreased minimum threshold RSSI value, reacquiring the cell and resuming the data call on the first subscription.

According to various aspects there is provided a multi-subscriber identity module (SIM) multi-standby (MSMS) mobile communication device. In some aspects, the MSMS mobile communication device may include: a communication unit at a transceiver, the transceiver of a plurality of receiver rake fingers; and a control unit operably connected to the communication unit.

The control unit may be configured to: control the communication unit to measure pilot signal energy of a cell on which a data call was suspended on a first subscription before tune-away to a second subscription; determine whether the measured pilot signal energy is less than a high threshold received signal strength indicator (RSSI) value; in response to determining that the measured pilot signal energy is less than the high threshold RSSI value, determine whether a difference between a measured cell timing and a pre-tune-away cell timing is less than a first threshold timing value; in response to determining that the difference between the measured cell timing and the pre-tune-away cell timing is less than the first threshold timing value, determine whether a strongest pilot signal energy received on one of a plurality of receiver rake fingers is greater than a low threshold RSSI value; in response to determining that the strongest pilot signal energy received on one of the plurality of receiver rake fingers is greater than the low threshold RSSI value, decrease the low threshold RSSI value for reacquiring the cell; determine, after controlling the communication unit to perform a next tune-away, whether the strongest pilot signal energy received on one of the plurality of receiver rake fingers is less than the decreased low threshold RSSI value; and in response to determining that the measured RSSI for the strongest pilot signal energy received on one of the plurality of the receiver rake fingers is not less than the decreased minimum threshold RSSI value, reacquire the cell and resume the data call on the first subscription.

According to various aspects there is provided a non-transitory computer readable medium. In some aspects, the non-transitory computer readable medium may include instructions for causing one or more processors of a multi-subscriber identity module (SIM) multi-standby (MSMS) mobile communication device to perform operations for reacquiring a cell after tune-away, the operations including: measuring pilot signal energy of a cell on which a data call was suspended on a first subscription before tune-away to a second subscription; determining whether the measured pilot signal energy is less than a high threshold received signal strength indicator (RSSI) value; in response to determining that the measured pilot signal energy is less than the high threshold RSSI value, determining whether a difference between a measured cell timing and a pre-tune-away cell timing is less than a first threshold timing value; in response to determining that the difference between the measured cell timing and the pre-tune-away cell timing is less than the first threshold timing value, determining whether a strongest pilot signal energy received on one of a plurality of receiver rake fingers is greater than a low threshold RSSI value; in response to determining that the strongest pilot signal energy received on one of the plurality of receiver rake fingers is greater than the low threshold RSSI value, decreasing the low threshold RSSI value for reacquiring the cell; determining, after a next tune-away, whether the strongest pilot signal energy received on one of the plurality of receiver rake fingers is less than the decreased low threshold RSSI value; and in response to determining that the measured RSSI for the strongest pilot signal energy received on one of the plurality of the receiver rake fingers is not less than the decreased minimum threshold RSSI value, reacquiring the cell and resuming the data call on the first subscription.

According to various aspects there is provided a multi-subscriber identity module (SIM) multi-standby (MSMS) mobile communication device. In some aspects, the MSMS is issues and review closely mobile communication device may include: means for measuring pilot signal energy of a cell on which a data call was suspended on a first subscription before tune-away to a second subscription; means for determining whether the measured pilot signal energy is less than a high threshold received signal strength indicator (RSSI) value; in response to determining that the measured pilot signal energy is less than the high threshold RSSI value, means for determining whether a difference between a measured cell timing and a pre-tune-away cell timing is less than a first threshold timing value; in response to determining that the difference between the measured cell timing and the pre-tune-away cell timing is less than the first threshold timing value, means for determining whether a strongest pilot signal energy received on one of a plurality of receiver rake fingers is greater than a low threshold RSSI value; in response to determining that the strongest pilot signal energy received on one of the plurality of receiver rake fingers is greater than the low threshold RSSI value, means for decreasing the low threshold RSSI value for reacquiring the cell; means for determining, after a next tune-away, whether the strongest pilot signal energy received on one of the plurality of receiver rake fingers is less than the decreased low threshold RSSI value; and in response to determining that the measured RSSI for the strongest pilot signal energy received on one of the plurality of the receiver rake fingers is not less than the decreased minimum threshold RSSI value, means for reacquiring the cell and resuming the data call on the first subscription.

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1A is a block diagram illustrating a mobile communication device according to various examples;

FIG. 1B is a diagram illustrating a network environment for various examples; and

FIG. 2 is a flowchart illustrating a method for reacquiring a cell after tune-away for a multi-subscriber identity module (SIM) multi-standby mobile communication device according to various examples.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

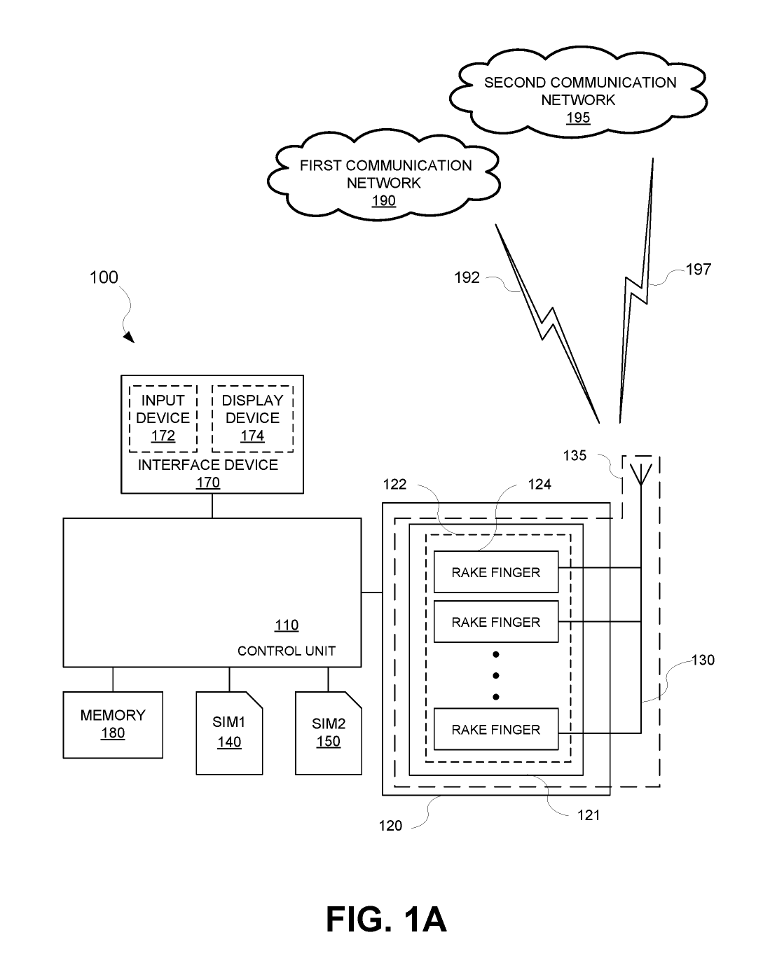

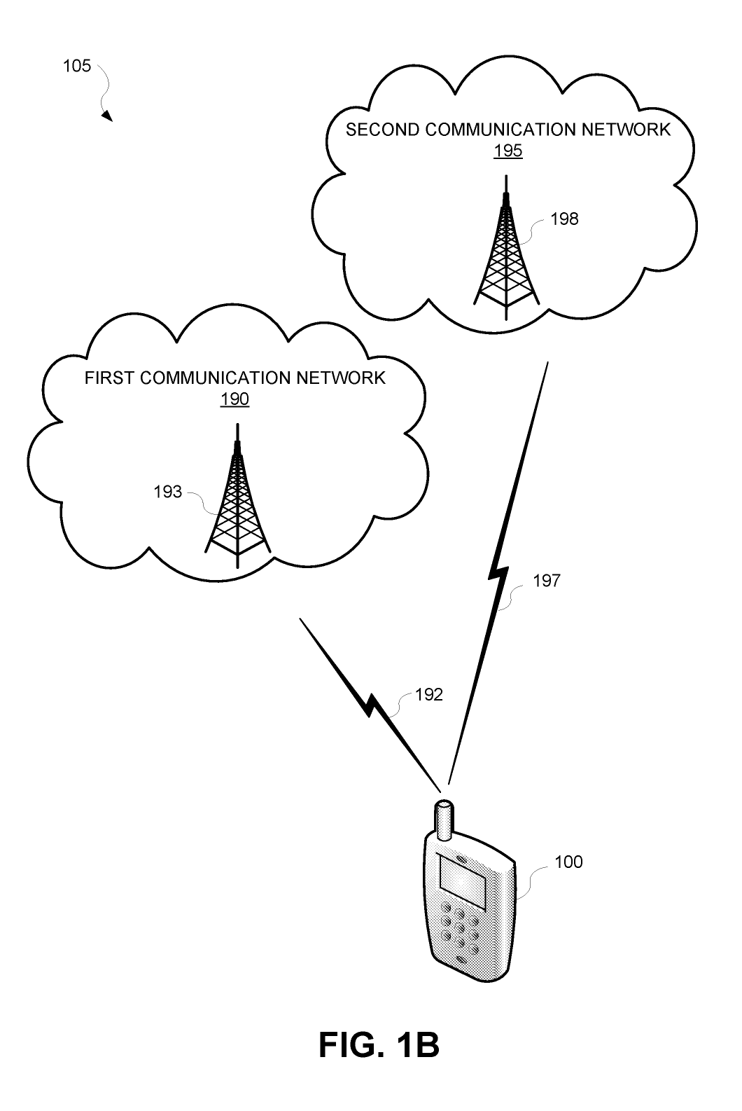

FIG. 1A is a block diagram illustrating a mobile communication device 100 according to various embodiments. As illustrated in FIG. 1A, the mobile communication device 100 may include a control unit 110, a communication unit 120, an antenna 130, a first subscriber identity module (SIM) 140, a second SIM 150, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more communication units and may interface with one or more antennas without departing from the scope of protection.

The communication unit 120 may include, for example, but not limited to, an RF module 121. The RF module 121 may include, for example, but not limited to a transceiver 122. An RF chain 135 may include, for example, but not limited to the antenna 130 and the RF module 121. The transceiver 122 may include a plurality of receiver rake fingers (also referred to herein as “taps”) 124 configured to decode signals received from various signal paths in a multi-path environment. For example, the transceiver 122 may have twelve fingers; however, not all of the fingers may be used at one time to decode received multi-path signals.

The multipath channel through which a radio wave is transmitted can be viewed as transmitting the original (e.g., line of sight) wave through a number of multipath components. Multipath components are delayed copies of the original transmitted wave traveling through different echo paths, each with a different magnitude and time-of-arrival at the receiver. Since each component contains the original information, the magnitude and time-of-arrival of each component may be computed at the transceiver 122 (e.g., through channel estimation process), and all the components added coherently.

One of ordinary skill in the art will appreciate that embodiments of the mobile communication device 100 may include more than one communication unit and/or more than one antenna without departing from the scope of protection.

A SIM (for example the first SIM 140 and/or the second SIM 150) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription (Sub1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 receives and transmits signals on the active RAT. When a RAT is idle, the communication unit 120 receives but does not transmit signals on the idle RAT.

For convenience, the various embodiments are described in terms of DSDS mobile communication devices. However, one of ordinary skill in the art will appreciate that the various embodiments may be extended to Multi-SIM Multi-Standby (MSMS) and/or Multi-SIM Multi-Active (MSMA) mobile communication devices without departing from the scope of protection.

The first communication network 190 and the second communication network 195 may be operated by the same or different service providers, and/or may support the same or different RATs, for example, but not limited to, GSM, CDMA, WCDMA, and long term evolution (LTE).

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the communication unit 120, the user interface device 170, and the memory 180. The control unit 110 may be a programmable device, for example, but not limited to, a microprocessor (e.g., general-purpose processor, baseband modem processor, etc.) or microcontroller.

The memory 180 may be configured to store operating systems and/or application programs for operation of the mobile communication device 100 that are executed by the control unit 110, as well as to store application data and user data.

FIG. 1B is a diagram illustrating a network environment 105 for various embodiments. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio access technologies (RATs). For example, the first communication network 190 may be a GSM network and the first subscription 192 may be a GSM subscription. The second communication network 195 may also be a GSM network. Alternatively, the second communication network 195 may implement another RAT including, for example, but not limited to, LTE, WCDMA, and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

Various examples may provide apparatuses and methods for reacquiring a cell and resuming a data call after tune away for a multi-SIM mobile communication device. In various examples, the mobile communication device 100 may support a data call on one subscription (e.g., Sub1 192) while tuning the RF chain 135 to a different frequency band to monitor the paging channel for another subscription (e.g., Sub2 197). For example, a data call may be established on a WCDMA RAT associated with Sub1 192 and a CDMA RAT associated with Sub2 197 may be in an idle state monitoring the paging channel periodically.

One of ordinary skill in the art will appreciate that the various embodiments are not limited to only these RATs on either subscription and that other RATs, for example, but not limited to, global system for mobile communications (GSM), long term evolution (LTE), etc., may be used in various combinations without departing from the scope of the disclosure. One of ordinary skill in the art will also appreciate that while various examples are described in terms of DSDS or MSMS mobile communication devices, the present concept is also applicable to single SIM mobile communication devices supporting a subscription on more than one frequency band without departing from the scope of the disclosure.

When an MSMS or a DSDS mobile communication device (e.g., the mobile communication device 100) is engaged in an active data call on one subscription (e.g., Sub1 192) and in idle state on another subscription (e.g., Sub2 197) the mobile communication device 100 may suspend and resume the data call on Sub1 192 periodically to permit page monitoring on Sub2 197. The periodic suspension and resumption of the data call on Sub1 192 may involve periodic attempts by the mobile communication device 100 to reacquire the cell on which the Sub1 192 data call was suspended. Frequent fluctuations of cell pilot energy may result in low pilot energy during acquisition attempts for a small duration, but the cell pilot energy may improve during subsequent acquisition attempts.

In various examples, when the mobile communication device 100 tunes back from monitoring a page on Sub2 197 to Sub1 192 to resume the data call, the mobile communication device 100 may measure the pilot signal energy of the cell on which the data call was suspended. If the measured pilot cell energy is not less than a high threshold energy value, the mobile communication device 100 may reacquire the cell and proceed with the data call on Sub1 192.

If the measured pilot cell energy is less than the high threshold energy value, the mobile communication device 100 may determine a difference between a latest measured cell timing and the pre-tune-away cell timing. If the difference is less than a first threshold timing value, the mobile communication device 100 may determine if the strongest measured pilot signal energy is greater than a low threshold received signal strength indicator (RSSI) value. In an example, if WCDMA is the RAT on Sub1 192, the measurement is essentially a pseudorandom noise (PN) code search. WCDMA may set a high threshold energy value equal to −23.5 dB, a low threshold energy value equal to −24 dB, and a first threshold timing value equal to two times the chip rate.

If the strongest measured pilot signal energy is greater than the low threshold RSSI value, the mobile communication device 100 may decrease the RSSI requirements for reacquiring the cell.

If, during a next tune away, the measured RSSI is not less than a minimum threshold RSSI value, the mobile communication device 100 may reacquire the cell and proceed with the data call. If the measured RSSI is less than the minimum threshold RSSI value, however, the mobile communication device 100 may declare a radio link failure.

On the other hand, if the difference between the latest measured cell timing and the pre-tune-away cell timing is not less than the first threshold timing value or the strongest measured pilot signal energy is not greater than the low threshold RSSI value, the mobile communication device 100 may determine whether a difference between any of a predetermined number N of pilot signals (i.e., the top N taps (receiver rake fingers 124) of the transceiver 122) having highest energy values are within a second threshold timing value of the pre-tune-away cell timing.

If the difference is less than the second threshold timing value, the mobile communication device 100 may determine whether a number of pilot signal energy measurement re-attempts is greater than a maximum reattempt threshold value. If the number of measurement re-attempts is not greater than the maximum reattempt threshold value, the mobile communication device 100 may reattempt the pilot signal energy measurements after a delay period sufficient to exceed the channel coherence time.

On the other hand, if the difference between any of the predetermined number of pilot signals having highest energy values are not within the second threshold timing value of the pre-tune-away cell timing or the number of measurement re-attempts is greater than the maximum reattempt threshold value, the mobile communication device 100 may declare a radio link failure.

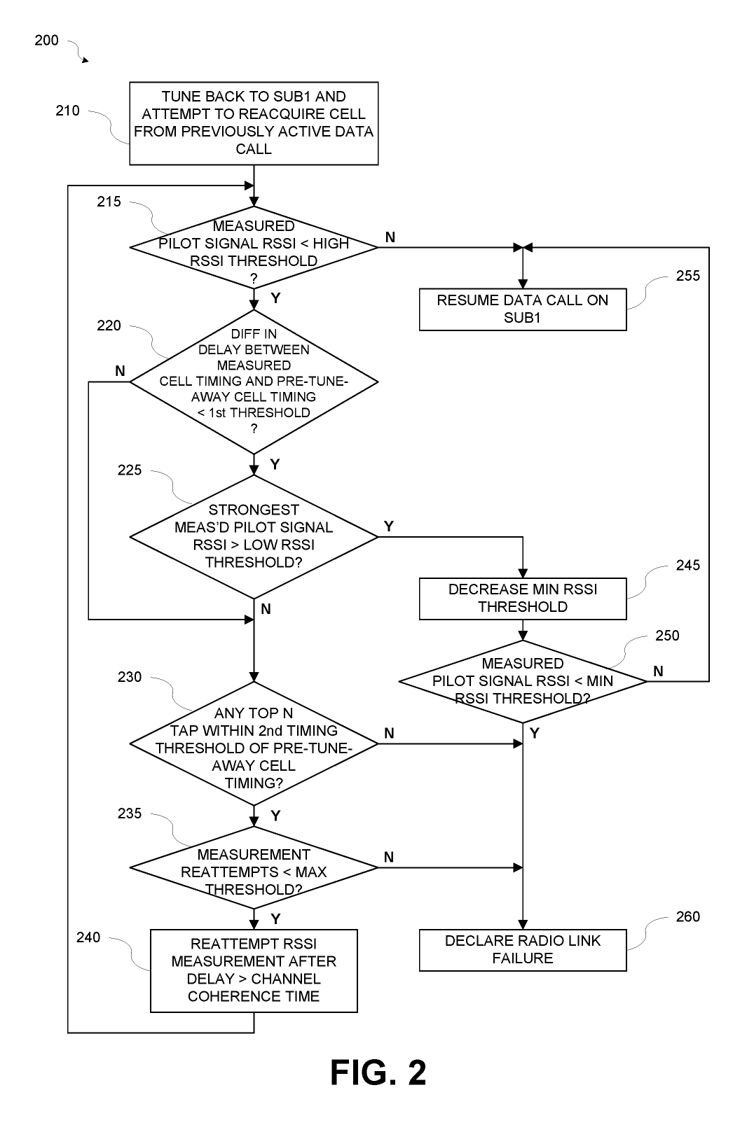

FIG. 2 is a flowchart illustrating a method 200 for reacquiring a cell after tune-away for a multi-subscriber identity module (SIM) multi-standby mobile communication device according to various examples.

Referring to FIG. 2, at block 210 the mobile communication device 100 may tune back from monitoring a page on Sub2 197 to Sub1 192 and attempt to reacquire the cell on which a data call on Sub2 192 was previously active. For example, the control unit 110 may control the communication unit 120 to tune back from a frequency band for Sub2 197 to a frequency band for Sub1 192. The control unit 110 may control the communication unit 120 to utilize a plurality of the receiver rake fingers 124 in the transceiver 122 to detect pilot signal energy (i.e., received signal strength indicator (RSSI)) from the cell on which the data call was previously active.

At block 215, the mobile communication device 100 may measure the pilot signal RSSI of the cell on which the data call was suspended before tune-away and determine whether the measured pilot signal RSSI is less than a high threshold RSSI value. For example, the control unit 110 may cause the communication unit 120 to coherently combine the detected pilot signal energy received by the plurality of receiver rake fingers 124 and determine if the coherently combined pilot signal RSSI is less than the high RSSI value. The high threshold RSSI value may be, for example, about −22 dB. One of ordinary skill in the art will appreciate that the high threshold RSSI value may be dependent upon the RAT, and may be less than or greater than −22 dB.

In response to determining that the measured pilot signal RSSI is not less than the high threshold RSSI value (215-N), at block 255 the mobile communication device 100 may reacquire the cell and resume the data call on Sub1 192. For example, the control unit 110 may control the communication unit 120 to reacquire the cell.

In response to determining that the measured pilot signal RSSI is less than the high threshold RSSI value (215-Y), at block 220 the mobile communication device 100 may determine whether a difference between a latest measured cell timing and a pre-tune-away cell timing is less than a first threshold timing value. For example, the control unit 110 may determine whether the difference between the delay in receiving the measured pilot signal RSSI and the delay in receiving the pilot signal RSSI prior to tune-away is less than a chip rate of the pilot signal. One of ordinary skill in the art will appreciate that the first threshold timing value for the measured pilot signal energy may be dependent upon the RAT, and may be less than or greater than chip rate of the pilot signal.

In response to determining that the difference is less than the first threshold timing value (220-Y), at block 225 the mobile communication device 100 may determine if the strongest measured pilot signal RSSI is greater than a low threshold RSSI value. For example, the control unit 110 may determine whether a strongest pilot signal RSSI received on one of the plurality of the receiver rake fingers 124 is greater than a low threshold RSSI value. The low threshold RSSI value for the strongest pilot signal RSSI received on one of the plurality of the receiver rake fingers 124 may be, for example, about −22 dB. One of ordinary skill in the art will appreciate that the low threshold RSSI value for the strongest pilot signal RSSI received on one of the plurality of the receiver rake fingers 124 may be dependent upon the RAT, and may be less than or greater than −22 dB.

In response to determining that the strongest measured pilot signal RSSI received on one of the plurality of the receiver rake fingers 124 is greater than the low threshold RSSI value (225-Y), at block 245 the mobile communication device 100 may decrease the low threshold RSSI value for reacquiring the cell. For example, the control unit 110 may decrease the low threshold RSSI value for the strongest pilot signal RSSI received on one of the plurality of the receiver rake fingers 124 to −24 dB. One of ordinary skill in the art will appreciate that the decreased low threshold RSSI value for the strongest pilot signal RSSI received on one of the plurality of the receiver rake fingers 124 may be dependent upon the RAT, and may be less than or greater than −24 dB.

At block 250, after a next tune-away the control unit 110 may determine whether the measured RSSI for the strongest pilot signal RSSI received on one of the plurality of the receiver rake fingers 124 is less than the decreased minimum threshold RSSI value. In response to determining that the measured RSSI for the strongest pilot signal RSSI received on one of the plurality of the receiver rake fingers 124 is not less than the decreased minimum threshold RSSI value (250-N), at block 255 the mobile communication device 100 may reacquire the cell and resume the data call. In response to determining that the measured RSSI for the strongest pilot signal RSSI received on one of the plurality of the receiver rake fingers 124 is less than the decreased minimum threshold RSSI value (250-Y), at block 260 the mobile communication device 100 may declare a radio link failure.

Referring again to block 220, in response to determining that the difference between the latest measured cell timing and the pre-tune-away cell timing is not less than the first threshold timing value (220-N), or the strongest measured pilot signal RSSI received on one of the plurality of the receiver rake fingers 124 is not greater than the low threshold RSSI value (225-N), at block 230 the mobile communication device 100 may determine whether a difference between a measured pilot signal having a highest RSSI value of any of a predetermined number N of received pilot signals (i.e., the top N taps (receiver rake fingers 124) of the transceiver 122) is within a second threshold timing value of the pre-tune-away cell timing. For example, the control unit 110 may determine whether the difference between the delay in receiving the measured pilot signal having the highest RSSI value and the delay in receiving the pilot signal RSSI prior to tune-away is within a chip rate of the pilot signal. One of ordinary skill in the art will appreciate that the second threshold timing value for the measured pilot signal having the highest RSSI value may be dependent upon the RAT, and may be less than or greater than the chip rate of the pilot signal.

In response to determining that the difference is not within than the second threshold timing value (230-N), at block 260 the mobile communication device 100 may declare a radio link failure. In response to determining that the difference is within than the second threshold timing value (230-Y), at block 235 the mobile communication device 100 may determine whether a number of pilot signal RSSI measurement re-attempts is greater than a maximum reattempt threshold value. For example, the control unit 110 may determine whether two attempts at measuring the pilot signal RSSI have been performed. One of ordinary skill in the art will appreciate that the maximum reattempt threshold value may be dependent upon the RAT, and may be less than or greater than two.

In response to determining that the number of measurement re-attempts is not less than the maximum reattempt threshold value (235-N), at block 260 the mobile communication device 100 may declare a radio link failure. In response to determining that the number of measurement re-attempts is less than the maximum reattempt threshold value (235-N), at block 240 the control unit 110 may control the communication unit 120 to reattempt the pilot signal RSSI measurements after a delay period sufficient to exceed the channel coherence time, and the method to continue at block 215.

The various examples may mitigate radio link failure for the data call resulting in better throughputs for the active data call session and overall better call retention performance.

The method 200 may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for reacquiring a cell after tune-away for a multi-subscriber identity module (SIM) multi-standby (MSMS) mobile communication device, the method comprising:
measuring pilot signal received signal strength indicator (RSSI) of a cell on which a data call was suspended on a first subscription before tune-away to a second subscription;
determining whether the measured RSSI is less than a high threshold RSSI value;
in response to determining that the measured RSSI is less than the high threshold RSSI value, determining whether a difference between a measured cell timing and a pre-tune-away cell timing is less than a first threshold timing value;
in response to determining that the difference between the measured cell timing and the pre-tune-away cell timing is less than the first threshold timing value, determining whether a strongest pilot signal RSSI received on one of a plurality of receiver rake fingers is greater than a low threshold RSSI value;
in response to determining that the strongest pilot signal RSSI received on one of the plurality of receiver rake fingers is greater than the low threshold RSSI value, decreasing the low threshold RSSI value for reacquiring the cell;
determining, after a next tune-away, whether the strongest pilot signal RSSI received on one of the plurality of receiver rake fingers is less than the decreased low threshold RSSI value; and
in response to determining that the measured RSSI for the strongest pilot signal received on one of the plurality of receiver rake fingers is not less than the decreased minimum threshold RSSI value, reacquiring the cell and resuming the data call on the first subscription.

2. The method of claim 1, further comprising:
in response to determining that the measured pilot signal RSSI is not less than the high threshold RSSI value, reacquiring the cell and resuming the data call on the first subscription.

3. The method of claim 1, further comprising:
in response to determining that the strongest pilot signal RSSI received on one of the plurality of receiver rake fingers is not greater than the low threshold RSSI value, determining whether a difference between a measured pilot signal having a highest RSSI value of any of a predetermined number N of received pilot signals is within a second threshold timing value of the pre-tune-away cell timing; and
in response to determining that the difference between the measured pilot signal having the highest RSSI value of any of the predetermined number N of received pilot signals is not within the second threshold timing value of the pre-tune-away cell timing, declaring a radio link failure.

4. The method of claim 3, further comprising:
in response to determining that the difference between the measured pilot signal having the highest RSSI value of any of the predetermined number N of received pilot signals is not within the second threshold timing value of the pre-tune-away cell timing, determining whether a number of pilot signal RSSI measurement re-attempts is greater than a maximum reattempt threshold value; and
in response to determining that the number of measurement re-attempts is not less than the maximum reattempt threshold value, declaring a radio link failure.

5. The method of claim 4, further comprising:
in response to determining that the number of measurement re-attempts is less than the maximum reattempt threshold value, reattempting the pilot signal RSSI measurements after a delay period sufficient to exceed a channel coherence time.

6. The method of claim 1, further comprising:
in response to determining that the measured RSSI for the strongest pilot signal received on one of the plurality of receiver rake fingers is not less than the decreased minimum threshold RSSI value, declaring a radio link failure.

7. The method of claim 1, further comprising:
in response to determining that the difference between the measured cell timing and the pre-tune-away cell timing is not less than the first threshold timing value, determining whether a difference between a measured pilot signal having a highest RSSI value of any of a predetermined number N of received pilot signals is within a second threshold timing value of the pre-tune-away cell timing;
in response to determining that the difference between the measured pilot signal having the highest RSSI value of any of the predetermined number N of received pilot signals is within the second threshold timing value of the pre-tune-away cell timing, determining whether a number of pilot signal RSSI measurement re-attempts is greater than a maximum reattempt threshold value; and
in response to determining that the number of measurement re-attempts is less than the maximum reattempt threshold value, reattempting the pilot signal RSSI measurements after a delay period sufficient to exceed a channel coherence time.

8. The method of claim 1, further comprising:
in response to determining that the difference between the measured cell timing and the pre-tune-away cell timing is not less than the first threshold timing value, determining whether a difference between a measured pilot signal having a highest RSSI value of any of a predetermined number N of received pilot signals is within a second threshold timing value of the pre-tune-away cell timing;
in response to determining that the difference between the measured pilot signal having the highest RSSI value of any of the predetermined number N of received pilot signals is not within the second threshold timing value of the pre-tune-away cell timing, declaring a radio link failure.

9. The method of claim 1, further comprising:
in response to determining that the strongest pilot signal RSSI received on one of the plurality of receiver rake fingers is not greater than the low threshold RSSI value, determining whether a difference between a measured pilot signal having a highest RSSI value of any of a predetermined number N of received pilot signals is within a second threshold timing value of the pre-tune-away cell timing;
in response to determining that the difference between the measured pilot signal having the highest RSSI value of any of the predetermined number N of received pilot signals is within the second threshold timing value of the pre-tune-away cell timing, determining whether a number of pilot signal RSSI measurement re-attempts is greater than a maximum reattempt threshold value; and
in response to determining that the number of measurement re-attempts is less than the maximum reattempt threshold value, reattempting the pilot signal RSSI measurements after a delay period sufficient to exceed a channel coherence time.

10. The method of claim 9, further comprising:
in response to determining that the difference between the measured pilot signal having the highest RSSI value of any of the predetermined number N of received pilot signals is within the second threshold timing value of the pre-tune-away cell timing, declaring a radio link failure.

11. The method of claim 9, further comprising:
in response to determining that the number of measurement re-attempts is less than the maximum reattempt threshold value, declaring a radio link failure.

12. A multi-subscriber identity module (SIM) multi-standby (MSMS) mobile communication device, comprising:
a communication unit having a transceiver, the transceiver including a plurality of receiver rake fingers; and
a control unit operably connected to the communication unit, the control unit configured to:
control the communication unit to measure pilot signal received signal strength indicator (RSSI) of a cell on which a data call was suspended on a first subscription before tune-away to a second subscription;
determine whether the measured RSSI is less than a high threshold RSSI value;
in response to determining that the measured RSSI is less than the high threshold RSSI value, determine whether a difference between a measured cell timing and a pre-tune-away cell timing is less than a first threshold timing value;
in response to determining that the difference between the measured cell timing and the pre-tune-away cell timing is less than the first threshold timing value, determine whether a strongest pilot signal RSSI received on one of a plurality of receiver rake fingers is greater than a low threshold RSSI value;
in response to determining that the strongest pilot signal RSSI received on one of the plurality of receiver rake fingers is greater than the low threshold RSSI value, decrease the low threshold RSSI value for reacquiring the cell;
determine, after controlling the communication unit to perform a next tune-away, whether the strongest pilot signal RSSI received on one of the plurality of receiver rake fingers is less than the decreased low threshold RSSI value; and
in response to determining that the measured RSSI for the strongest pilot signal RSSI received on one of the plurality of receiver rake fingers is not less than the decreased minimum threshold RSSI value, reacquire the cell and resume the data call on the first subscription.

13. The MSMS mobile communication device of claim 12, wherein the control unit is further configured to:
in response to determining that the measured pilot signal RSSI is not less than the high threshold RSSI value, reacquiring the cell and resuming the data call on the first subscription.

14. The MSMS mobile communication device of claim 12, wherein the control unit is further configured to:
in response to determining that the strongest pilot signal RSSI received on one of the plurality of receiver rake fingers is not greater than the low threshold RSSI value, determine whether a difference between a measured pilot signal having a highest RSSI value of any of a predetermined number N of received pilot signals is within a second threshold timing value of the pre-tune-away cell timing; and
in response to determining that the difference between the measured pilot signal having the highest RSSI value of any of the predetermined number N of received pilot signals is not within the second threshold timing value of the pre-tune-away cell timing, declare a radio link failure.

15. The MSMS mobile communication device of claim 14, wherein the control unit is further configured to:
in response to determining that the difference between the measured pilot signal having the highest RSSI value of any of the predetermined number N of received pilot signals is not within the second threshold timing value of the pre-tune-away cell timing, determine whether a number of pilot signal RSSI measurement re-attempts is greater than a maximum reattempt threshold value; and
in response to determining that the number of measurement re-attempts is not less than the maximum reattempt threshold value, declare a radio link failure.

16. The MSMS mobile communication device of claim 15, wherein the control unit is further configured to:
in response to determining that the number of measurement re-attempts is less than the maximum reattempt threshold value, control the communication unit to reattempt the pilot signal RSSI measurements after a delay period sufficient to exceed a channel coherence time.

17. The MSMS mobile communication device of claim 12, wherein the control unit is further configured to:
in response to determining that the measured RSSI for the strongest pilot signal energy received on one of the plurality of receiver rake fingers is not less than the decreased minimum threshold RSSI value, declare a radio link failure.

18. The MSMS mobile communication device of claim 12, wherein the control unit is further configured to:
in response to determining that the difference between the measured cell timing and the pre-tune-away cell timing is not less than the first threshold timing value, determine whether a difference between a measured pilot signal having a highest RSSI value of any of a predetermined number N of received pilot signals is within a second threshold timing value of the pre-tune-away cell timing;
in response to determining that the difference between the measured pilot signal having the highest RSSI value of any of the predetermined number N of received pilot signals is within the second threshold timing value of the pre-tune-away cell timing, determine whether a number of pilot signal RSSI measurement re-attempts is greater than a maximum reattempt threshold value; and
in response to determining that the number of measurement re-attempts is less than the maximum reattempt threshold value, control the communication unit to reattempt the pilot signal RSSI measurements after a delay period sufficient to exceed a channel coherence time.

19. The MSMS mobile communication device of claim 12, wherein the control unit is further configured to:
in response to determining that the difference between the measured cell timing and the pre-tune-away cell timing is not less than the first threshold timing value, determine whether a difference between a measured pilot signal having a highest RSSI value of any of a predetermined number N of received pilot signals is within a second threshold timing value of the pre-tune-away cell timing;
in response to determining that the difference between the measured pilot signal having the highest RSSI value of any of the predetermined number N of received pilot signals is not within the second threshold timing value of the pre-tune-away cell timing, declare a radio link failure.

20. The MSMS mobile communication device of claim 12, wherein the control unit is further configured to:
in response to determining that the strongest pilot signal RSSI received on one of the plurality of receiver rake fingers is not greater than the low threshold RSSI value, determine whether a difference between a measured pilot signal having a highest RSSI value of any of a predetermined number N of received pilot signals is within a second threshold timing value of the pre-tune-away cell timing;
in response to determining that the difference between the measured pilot signal having the highest RSSI value of any of the predetermined number N of received pilot signals is within the second threshold timing value of the pre-tune-away cell timing, determine whether a number of pilot signal RSSI measurement re-attempts is greater than a maximum reattempt threshold value; and
in response to determining that the number of measurement re-attempts is less than the maximum reattempt threshold value, control the communication unit to reattempt the pilot signal RSSI measurements after a delay period sufficient to exceed a channel coherence time.

21. The MSMS mobile communication device of claim 20, wherein the control unit is further configured to:
in response to determining that the difference between the measured pilot signal having the highest RSSI value of any of the predetermined number N of received pilot signals is within the second threshold timing value of the pre-tune-away cell timing, declare a radio link failure.

22. The MSMS mobile communication device of claim 20, wherein the control unit is further configured to:
in response to determining that the number of measurement re-attempts is less than the maximum reattempt threshold value, declare a radio link failure.

23. A non-transitory computer readable medium having stored therein instructions for causing one or more processors of a multi-subscriber identity module (SIM) multi-standby (MSMS) mobile communication device to perform operations for reacquiring a cell after tune-away, the operations comprising:
measuring pilot signal received signal strength indicator (RSSI) of a cell on which a data call was suspended on a first subscription before tune-away to a second subscription;
determining whether the measured RSSI is less than a high threshold RSSI value;
in response to determining that the measured RSSI is less than the high threshold RSSI value, determining whether a difference between a measured cell timing and a pre-tune-away cell timing is less than a first threshold timing value;
in response to determining that the difference between the measured cell timing and the pre-tune-away cell timing is less than the first threshold timing value, determining whether a strongest pilot signal RSSI received on one of a plurality of receiver rake fingers is greater than a low threshold RSSI value;
in response to determining that the strongest pilot signal RSSI received on one of the plurality of receiver rake fingers is greater than the low threshold RSSI value, decreasing the low threshold RSSI value for reacquiring the cell;
determining, after a next tune-away, whether the strongest pilot signal RSSI received on one of the plurality of receiver rake fingers is less than the decreased low threshold RSSI value; and
in response to determining that the measured RSSI for the strongest pilot signal received on one of the plurality of receiver rake fingers is not less than the decreased minimum threshold RSSI value, reacquiring the cell and resuming the data call on the first subscription.

24. The non-transitory computer readable medium having stored therein instructions as defined in claim 23, the instructions further including:
in response to determining that the measured pilot signal RSSI is not less than the high threshold RSSI value, reacquiring the cell and resuming the data call on the first subscription.

25. The non-transitory computer readable medium having stored therein instructions as defined in claim 23, the instructions further including:
in response to determining that the difference between the measured cell timing and the pre-tune-away cell timing is not less than the first threshold timing value, determining whether a difference between a measured pilot signal having a highest RSSI value of any of a predetermined number N of received pilot signals is within a second threshold timing value of the pre-tune-away cell timing;
in response to determining that the difference between the measured pilot signal having the highest RSSI value of any of the predetermined number N of received pilot signals is within the second threshold timing value of the pre-tune-away cell timing, determining whether a number of pilot signal RSSI measurement re-attempts is greater than a maximum reattempt threshold value; and
in response to determining that the number of measurement re-attempts is less than the maximum reattempt threshold value, reattempting the pilot signal RSSI measurements after a delay period sufficient to exceed a channel coherence time.

26. The non-transitory computer readable medium having stored therein instructions as defined in claim 23, the instructions further including:
in response to determining that the strongest pilot signal RSSI received on one of the plurality of receiver rake fingers is not greater than the low threshold RSSI value, determining whether a difference between a measured pilot signal having a highest RSSI value of any of a predetermined number N of received pilot signals is within a second threshold timing value of the pre-tune-away cell timing;
in response to determining that the difference between the measured pilot signal having the highest RSSI value of any of the predetermined number N of received pilot signals is within the second threshold timing value of the pre-tune-away cell timing, determining whether a number of pilot signal RSSI measurement re-attempts is greater than a maximum reattempt threshold value; and
in response to determining that the number of measurement re-attempts is less than the maximum reattempt threshold value, reattempting the pilot signal RSSI measurements after a delay period sufficient to exceed a channel coherence time.

27. A multi-subscriber identity module (SIM) multi-standby (MSMS) mobile communication device, comprising:
means for measuring pilot signal received signal strength indicator (RSSI) of a cell on which a data call was suspended on a first subscription before tune-away to a second subscription;
means for determining whether the measured RSSI is less than a high threshold RSSI value;
in response to determining that the measured RSSI is less than the high threshold RSSI value, means for determining whether a difference between a measured cell timing and a pre-tune-away cell timing is less than a first threshold timing value;
in response to determining that the difference between the measured cell timing and the pre-tune-away cell timing is less than the first threshold timing value, means for determining whether a strongest pilot signal RSSI received on one of a plurality of receiver rake fingers is greater than a low threshold RSSI value;
in response to determining that the strongest pilot signal RSSI received on one of the plurality of receiver rake fingers is greater than the low threshold RSSI value, means for decreasing the low threshold RSSI value for reacquiring the cell;
means for determining, after a next tune-away, whether the strongest pilot signal RSSI received on one of the plurality of receiver rake fingers is less than the decreased low threshold RSSI value; and
in response to determining that the measured RSSI for the strongest pilot signal RSSI received on one of the plurality of receiver rake fingers is not less than the decreased minimum threshold RSSI value, means for reacquiring the cell and resuming the data call on the first subscription.

28. The MSMS mobile communication device of claim 27, further comprising:
in response to determining that the measured pilot signal RSSI is not less than the high threshold RSSI value, means for reacquiring the cell and resuming the data call on the first subscription.

29. The MSMS mobile communication device of claim 27, further comprising:
in response to determining that the difference between the measured cell timing and the pre-tune-away cell timing is not less than the first threshold timing value, means for determining whether a difference between a measured pilot signal having a highest RSSI value of any of a predetermined number N of received pilot signals is within a second threshold timing value of the pre-tune-away cell timing;
in response to determining that the difference between the measured pilot signal having the highest RSSI value of any of the predetermined number N of received pilot signals is within the second threshold timing value of the pre-tune-away cell timing, means for determining whether a number of pilot signal RSSI measurement re-attempts is greater than a maximum reattempt threshold value; and
in response to determining that the number of measurement re-attempts is less than the maximum reattempt threshold value, means for reattempting the pilot signal RSSI measurements after a delay period sufficient to exceed a channel coherence time.

30. The MSMS mobile communication device of claim 27, further comprising:
in response to determining that the strongest pilot signal RSSI received on one of the plurality of receiver rake fingers is not greater than the low threshold RSSI value, means for determining whether a difference between a measured pilot signal having a highest RSSI value of any of a predetermined number N of received pilot signals is within a second threshold timing value of the pre-tune-away cell timing;
in response to determining that the difference between the measured pilot signal having the highest RSSI value of any of the predetermined number N of received pilot signals is within the second threshold timing value of the pre-tune-away cell timing, means for determining whether a number of pilot signal RSSI measurement re-attempts is greater than a maximum reattempt threshold value; and
in response to determining that the number of measurement re-attempts is less than the maximum reattempt threshold value, means for reattempting the pilot signal RSSI measurements after a delay period sufficient to exceed a channel coherence time.
